(19) United States
(12) Patent Application Publication
(10) Pub. No.: US 2009/0184941 A1
(43) Pub. Date: Jul. 23, 2009

(54) Structure of an andio device

(75) Inventors: Zhi-Jian Liao, Taipei (TW); Guo-Rui Han, Taipei (TW)

Correspondence Address: BACON & THOMAS, PLLC, 625 SLATERS LANE, FOURTH FLOOR, ALEXANDRIA, VA, 22314-1176, US

(73) Assignee: KYE SYSTEMS CORP., Taipei (TW)

(21) Appl. No.: 12/071,743

(22) Filed: Feb. 26, 2008

(30) Foreign Application Priority Data
Jan. 18, 2008 (TW) 097102106

(51) Int. Cl. G06F 3/042

(52) U.S. Cl. 345/175

(57) ABSTRACT

An image displaying device includes a housing accommodating a circuit board, a screen, and at least an optical trace detecting module. The optical trace detecting module has a light source and an image sensor for detecting movement of a user's finger thereon so as to generate and supply a corresponding moving signal to a micro control unit. The micro control unit generates a first control signal for adjusting or switching displayed images on the screen.

### BACKGROUND OF THE INVENTION

1. Field of the Invention

The present invention relates to an image displaying device, and in particular to a unique structure and control method of an image displaying device.

2. Description of the Prior Art

Common image displaying devices, such as a digital photo frame, usually have several control buttons that enable a user to change the way images are displayed, for example by enlarging, shrinking, or rotating the displayed image, or by causing the images to be displayed either in order or randomly.

A problem with the conventional buttons or switches is that they detract from the visual appearance of the flat and relatively narrow control panel at the base of the display. In addition, a regular control button or switch is always dim. The buttons or switches cannot promote the overall visual effect of the display device, and are particularly unattractive when attempting to achieve a photo frame effect.

### SUMMARY OF THE DISCLOSURE

It is accordingly an object of the present invention to provide an image displaying device having an improved appearance.

To accomplish the advantage mentioned above, the invention provides an image displaying structure or device including a housing accommodating a circuit board, a screen, and at least an optical trace detecting module. The optical trace detecting module has a light source and an image sensor for detecting movement of a user's finger thereon so as to generate and supply a corresponding moving signal to a micro control unit of the circuit. The micro control unit generates a first control signal for adjusting or switching displayed images.

### BRIEF DESCRIPTION OF THE DRAWINGS

FIG. 1 is an isometric view of a first preferred embodiment of the present invention.

FIG. 2 is a cross-sectional side view of the first preferred embodiment.

FIG. 3 is a block diagram of the first preferred embodiment.

FIG. 4 and 5 are cross-sectional side views of a second preferred embodiment of the present invention.

FIG. 6 is a block diagram of the second preferred embodiment.

FIG. 7 is an isometric view of the second preferred embodiment.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The image displaying device or audio system includes but is not limited to a monitor or a digital photo frame.

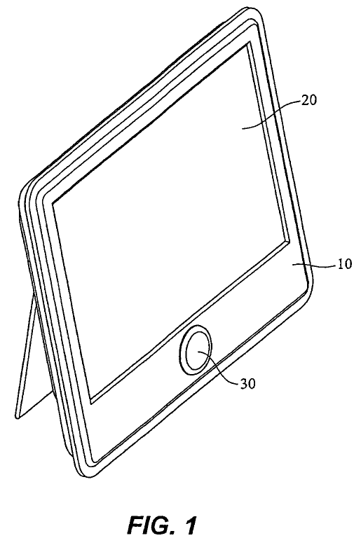

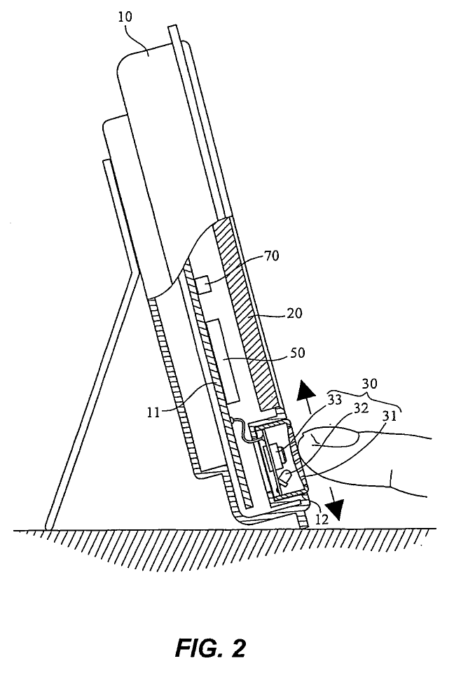

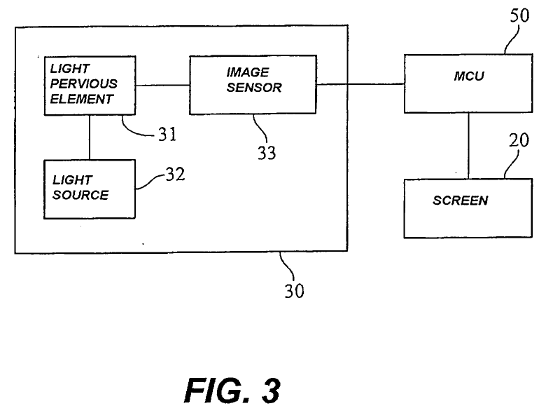

FIGS. 1-3 illustrate the first preferred embodiment of the present invention. The image displaying device, such as a digital photo frame, may be coupled to a memory card, or a built-in memory device in which images are stored. The image displaying device generally has a housing 10, a circuit board 11, and a screen 20 according to prior art. The image displaying device further has an optical trace detecting module 30 which is coupled to a micro control unit (MCU) 50. Once the MCU 50 receives an appropriate moving signal generated by optical trace detecting module 30, the MCU 50 will output a first control signal such that the displayed image(s) on the screen 20 can be adjusted or switched.

The optical trace detecting module 30 has a light source 32, an image sensor 33, and a light pervious or light transmitting element 31. The light transmitting element 31 can be a lens that is accessible or protrudes through an opening 12.

When a user moves his finger upon the light transmitting element 31 in an upward direction, the image may be switched or scrolled upward. On the other hand, when the user moves his finger upon the light transmitting element 31 in a downward direction, the image may be switched or scrolled downward. When the user moves his finger upon the light transmitting element 31 in a leftward direction, the image may be switched to the previous one or scrolled leftward. In contrast, when user moves his finger upon the light transmitting element 31 in a rightward direction, the image may be switched to the next one or scrolled rightward as well. Furthermore, when the user moves his finger upon the light transmitting element 31 according to a specific pattern, such as curve, circle, spiral, or figure “8,” a display-in-order or display-in-random visual effect may be activated to display multiple pictures randomly or in a predetermined order. However, if the user reverses his previous finger movement, the visual effect can be canceled.

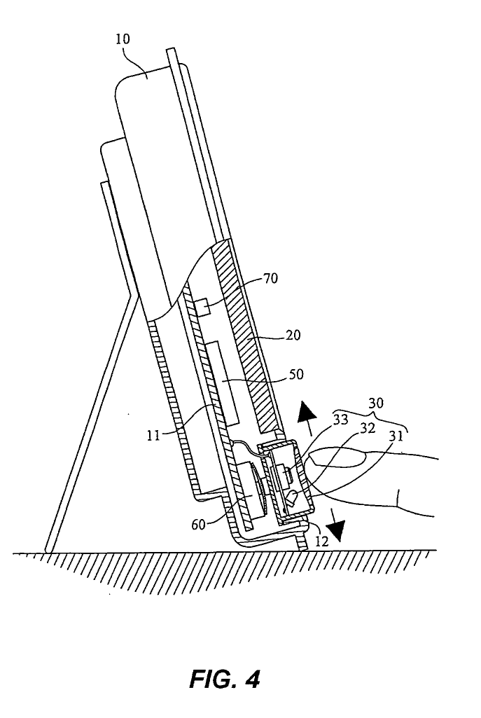

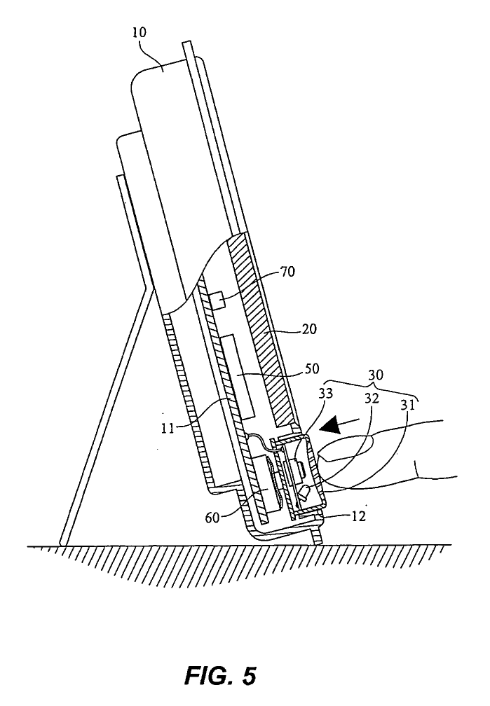

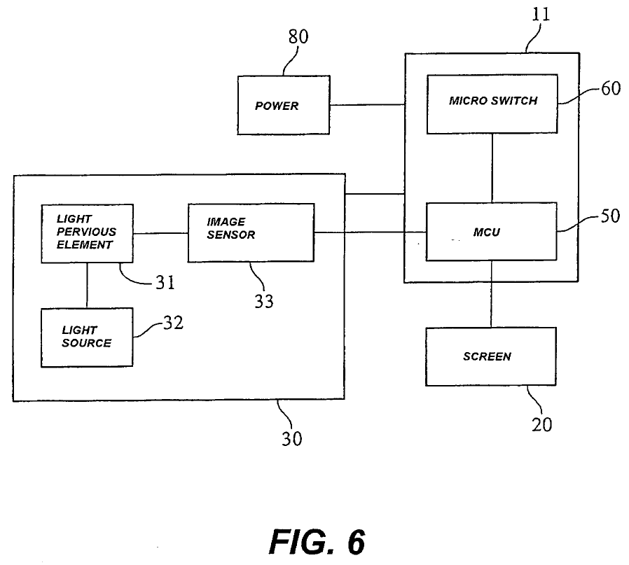

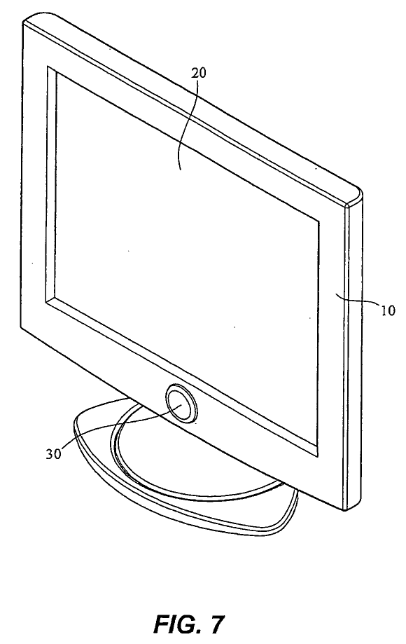

FIGS. 4-7 illustrate a second preferred embodiment of the present invention, in which a micro switch 60 on the circuit board 11 is positioned next to the optical trace detecting module 140 such that the when the user pushes the optical trace detecting module 30 toward the housing 10, the micro switch 60 is activated and the MCU 50 generates a second control signal. For example, when the user pushes in the optical trace detecting module 30 by pushing on light transmitting element 31, a display-in-random visual effect may be immediately activated. If the user pushes the light transmitting element 31 again, the present visual effect can be canceled and a display-in-order visual effect initiated. The optical trace detecting module 30 and the micro switch 60 can be assembled as a single unit, or multiple optical trace detecting modules and/or micro switches may be provided. Instead of switching between visual effects, the micro switch 60 could also be assigned to switch on or off the power supply 80 of the digital photo frame.

Alternatively, the micro switch 60 could be used to cause a “function selecting list/menu” to be shown on the screen 20. The user may move his fingers on the light transmitting element 31 up or down (left or right) so as to select a desired function on the list. In the meantime, once the user activates the micro switch 60 again, the desired function can be promptly executed or further modified. The functions selecting list/menu may relate to adjustment of the screen, such as Brightness, Contrast, Color, or Reset.

Because the light source 32 always keeps projecting a light beam on the light transmitting element 31, the arrangement of the invention has the additional advantage of adding a shining visual effect to the image display device.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A structure of an image displaying device, comprising:
a housing accommodating a circuit board and at least an optical trace detecting module;
wherein the circuit board has a micro control unit and a memory and the optical trace detecting module is coupled to the micro control unit;
wherein the optical trace detecting module at least has a light source and a image sensor for detecting a user's finger moving thereon so as to generate a corresponding moving signal, which is supplied to the micro control unit;
whereby, in response to the moving signal, the micro control unit generates a first control signal for adjusting or switching displayed images.

2. The image displaying device structure as claimed in claim 1, wherein the optical trace detecting module is movable, and a micro switch is next to the optical trace detecting module; wherein the micro switch generates a second control signal when the detecting module is pushed by the user.

3. The image displaying device structure as claimed in claim 2, wherein the microswitch switches between random and sequential image display functions.

4. The image displaying device structure as claimed in claim 2, wherein the microswitches switches a power supply for the image displaying device.

5. The image displaying device structure as claimed in claim 1, wherein a top of the optical trace detecting module further has a light transmitting element for placing the user's finger.

6. A method for adjusting or switching displayed image, comprising:
providing a housing for accommodating a circuit board, a screen, and at least an optical trace detecting module;
causing the optical trace detecting module to detect movement of a user's finger thereon and generate a corresponding moving signal, and supplying the moving signal to a micro control unit to cause the micro control unit to generates a first control signal for adjusting or switching the displayed image on the screen; and
causing the optical trace detecting module to move relative to the housing and activate a micro switch for generating a second control signal.

7. A digital photo frame, comprising:
a housing accommodating a circuit board and at least an optical trace detecting module;
wherein the circuit board has a micro control unit and a memory and the optical trace detecting module is coupled to the micro control unit; and
wherein the optical trace detecting module at least has a light source and a image sensor for detecting a user's finger moving thereon so as to generate a corresponding moving signal, which is supplied to the micro control unit, the micro control unit generating a first control signal for adjusting or switching displayed images.

8. The digital photo frame as claimed in claim 8, wherein the optical trace detecting module is movable, and a micro switch is next to the optical trace detecting module; wherein the micro switch generates a second control signal when the detecting module is pushed by the user.

9. The digital photo frame as claimed in claim 9, wherein the microswitch switches between random and sequential image display functions.

10. The digital photo frame as claimed in claim 9, wherein the microswitches switches a power supply for the image displaying device.

11. The digital photo frame as claimed in claim 8, wherein a top of the optical trace detecting module further has a light transmitting element for placing the user's finger.
